(19) United States
(12) Patent Application Publication
(10) Pub. No.: US 2007/0088575 A1
(43) Pub. Date: Apr. 19, 2007

(54) Method and apparatus for monitoring and treating medical signs and symptoms

(76) Inventors: Michael L. Byer, Gaithersburg, MD (US); Bernard M. Snyder, Bethesda, MD (US)

Correspondence Address: PATTON BOGGS LLP, 2550 M STREET NW, WASHINGTON, DC, 20037-1350, US

(21) Appl. No.: 11/543,064

(22) Filed: Oct. 5, 2006

Related U.S. Application Data
(62) Division of application No. 10/429,736, filed on May 6, 2003.

(51) Int. Cl. G06Q 10/00

(52) U.S. Cl. 705/2

(57) ABSTRACT

A method may identify, through a form, one or more medical signs, medical symptoms and/or medication side effects. The method may also record, through the form, one or more medical signs, medical symptoms and/or medication side effects associated with a person. The method may then identify, through the form, one or more medications that alleviates the one or more medical signs, medical symptoms and/or medication side effects associated with the person. The form may be a hardcopy and/or electronic form.

### RESERVATION OF COPYRIGHT

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The present invention relates to medical signs and/or symptoms. More particularly, the present invention relates, for example, to monitoring and treating the medical signs and/or symptoms.

### DESCRIPTION OF BACKGROUND INFORMATION

Epidemiological studies repeatedly provide evidence, for example, for a considerable incidence of major depression, anxiety disorders and/or bipolar mood disorders (manic depressive illness) in the general population. At the same time, a disappointingly small percentage of people are properly treated for their symptoms and/or condition.

Recent data suggest some twenty-five percent of women and ten percent of men in the United States will have major depression at some point in their life. Yet only forty percent of individuals with a major depression will receive treatment and in only fifteen percent of instances is it of adequate dose and duration. The World Health Organization indicates that depression is the number one ranked illness for causing disability, ahead of heart attacks, strokes and cancer. Bipolar illness is the number six cause of disability.

The consequences of untreated depression go well beyond its associated suffering, disability, and potential for suicide. It is a high risk factor for cardiovascular diseases for example as well as chronic pain syndromes. Individuals who are depressed are two to four times more likely to suffer from a heart attack than those not depressed and further are two to four times more likely to die of a heart attack.

As another example, the incidence of chronic pain syndromes is directly proportional to the number of depressive symptoms. Those with major depression are far more likely to suffer from a chronic pain syndrome than those without. Even difficulty stopping smoking is highly associated with a history of depression and anxiety syndromes.

Yet while many physicians are aware of these statistics, depression, for one, all too often falls off the medical agenda in a time-pressured medical visit. A person's symptoms and/or condition such as, for example, depression and/or associated anxiety symptoms should be recognized and treated.

### BRIEF DESCRIPTION OF THE DRAWINGS

In the drawings, like reference numerals represent similar parts of the illustrated embodiments of the present invention throughout the several views and wherein:

FIG. 1 is one embodiment of an apparatus;

FIG. 2 is another embodiment of the apparatus of FIG. 1;

FIG. 3 is one embodiment of a method to monitor and treat, for example, signs, symptoms and/or side effects; and

FIG. 4 is another embodiment of an apparatus.

### DETAILED DESCRIPTION

For example, use of a self-screening instrument may circumvent the problem identified above, as the self recognition of symptoms may be presented to a physician and/or clinician for evaluation and condition diagnosis. One embodiment of an apparatus (e.g., a form) may include, for example, a screening instrument such as, for example, a patient checklist of pertinent symptoms.

The screening instrument may be a self-rating device, which may facilitate the discussion to treat these symptoms in an otherwise busy medical practice where discussion of other medical symptoms may be the main focus. The self-rating device may also benefit individuals by allowing them ample opportunity to ponder and respond without encumbrances from health care providers presence, which may generate discomfort and/or uneasiness leading to confused, unconsciously withheld, consciously suppressed (e.g., suppressed for fear of embarrassment) and/or miscommunicated information (e.g., medical and/or biographical information). The self-rating device further confers decision-making empowerment to individuals.

The apparatus may also include an overview (e.g., a brief overview) of available medications and a follow up instrument on symptom improvement and/or possible side effects. The apparatus may aid in enhancing treatment initiation, monitoring and/or maintaining long term improvement in this underserved domain of general medical practice.

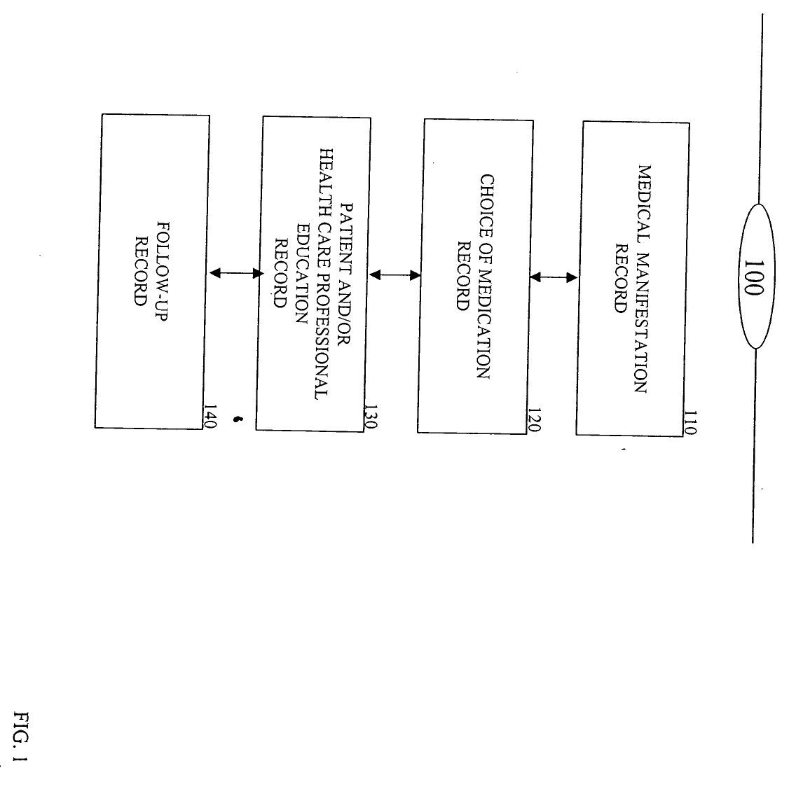

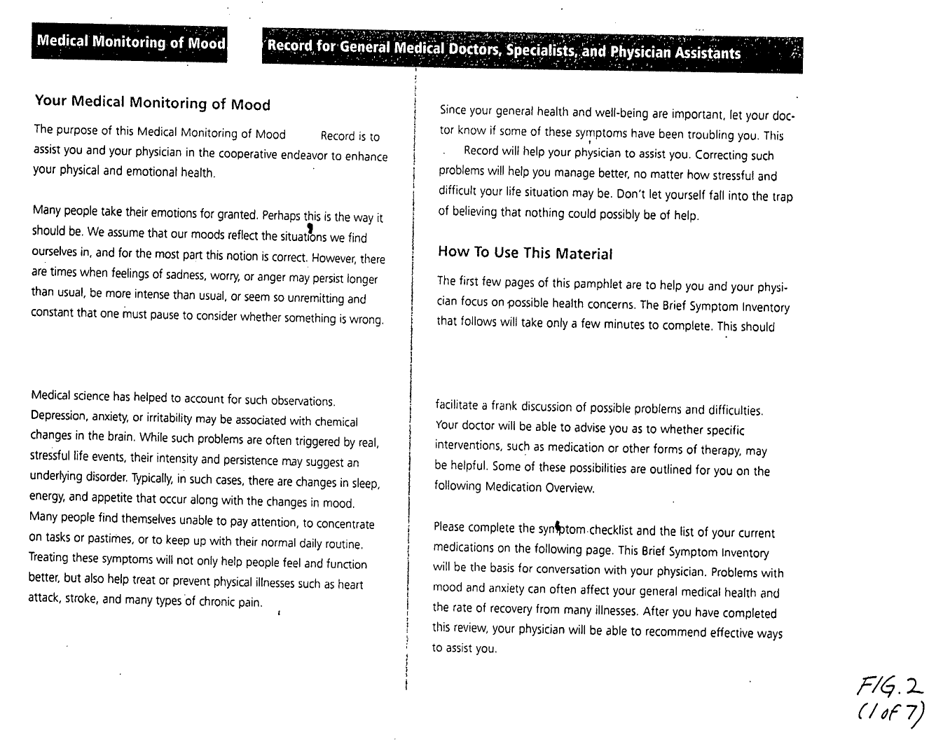

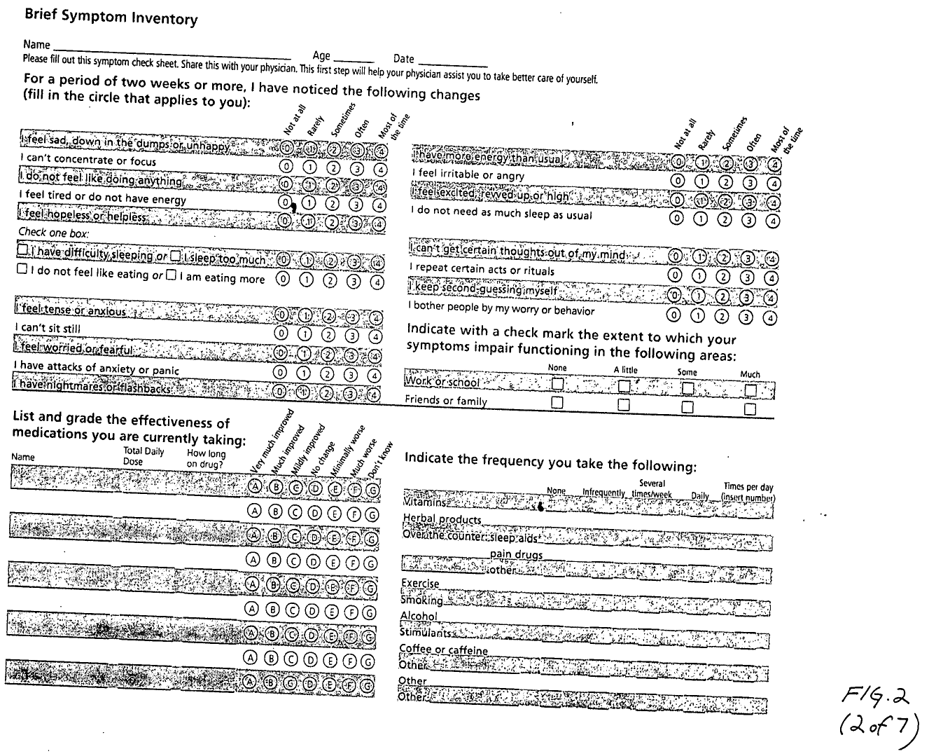

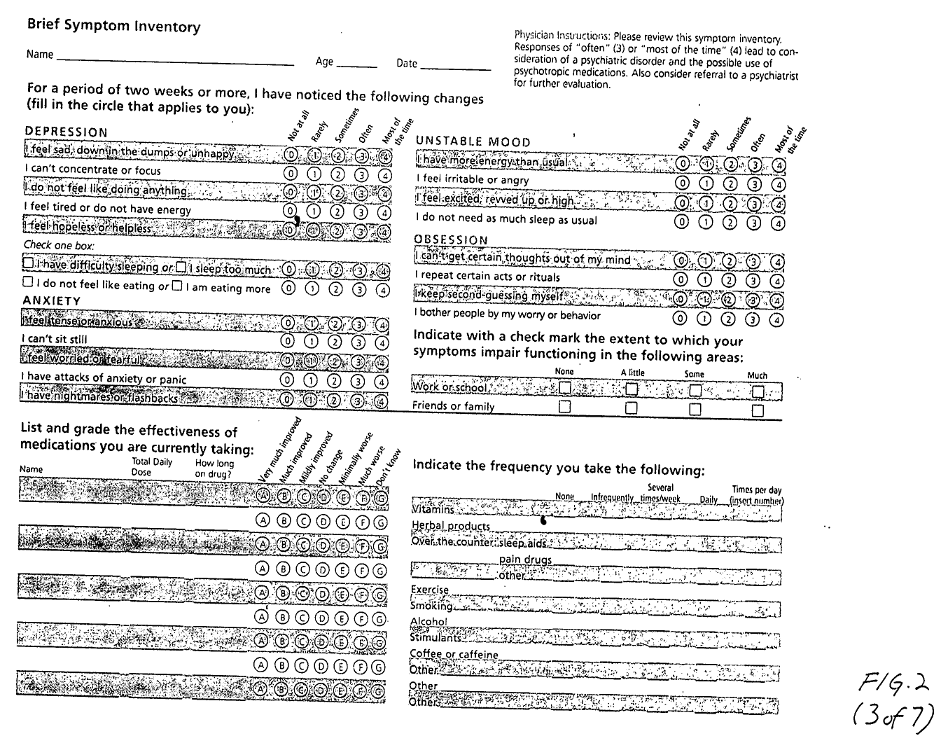

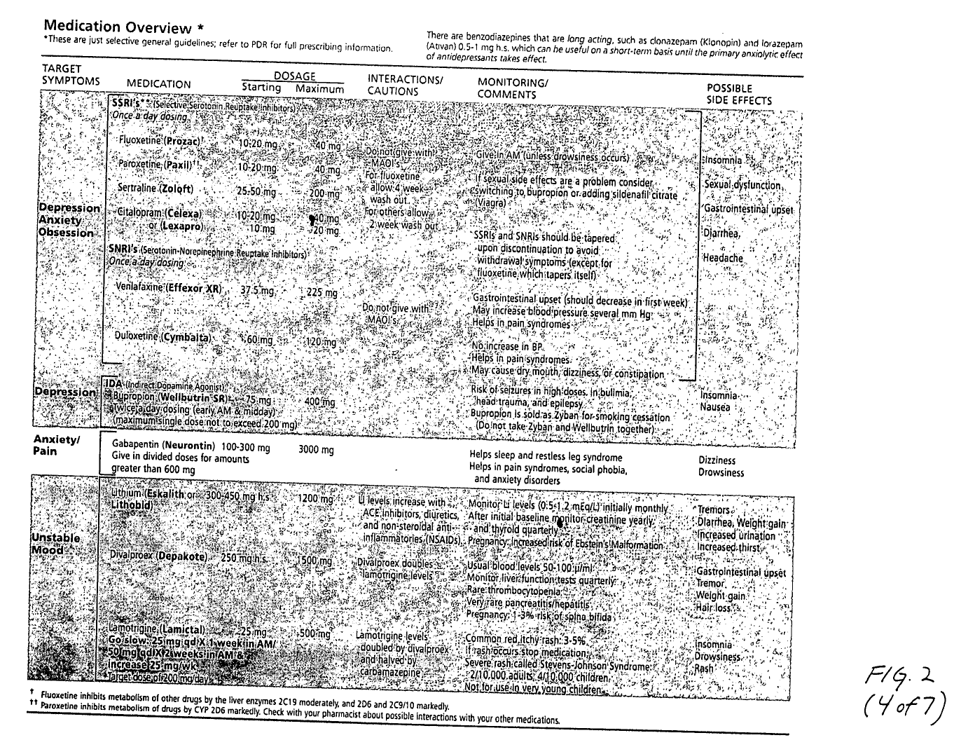

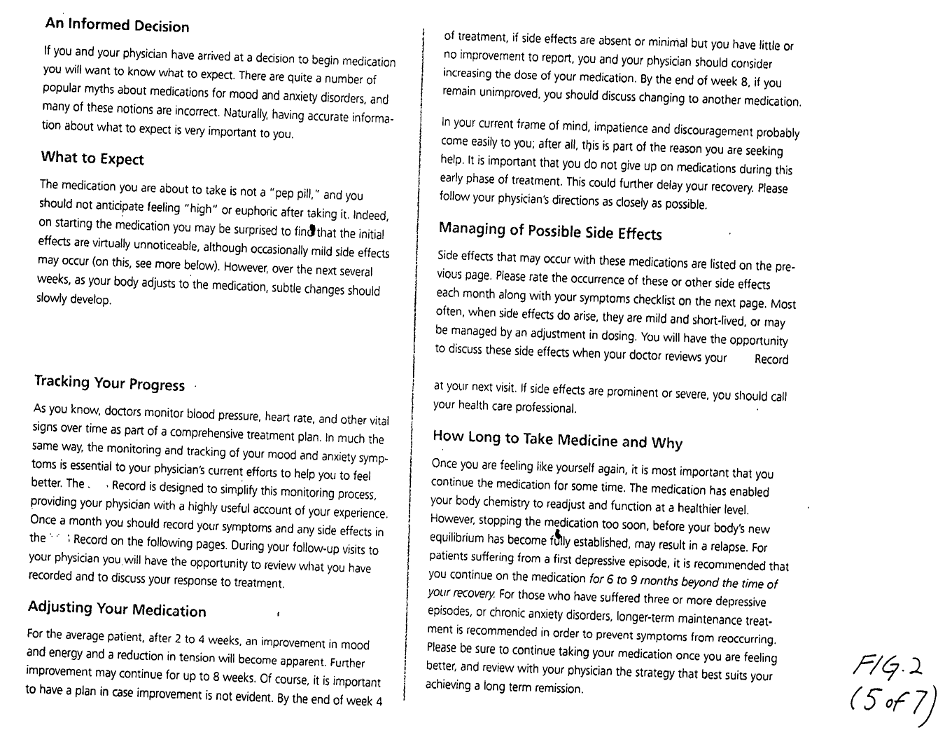

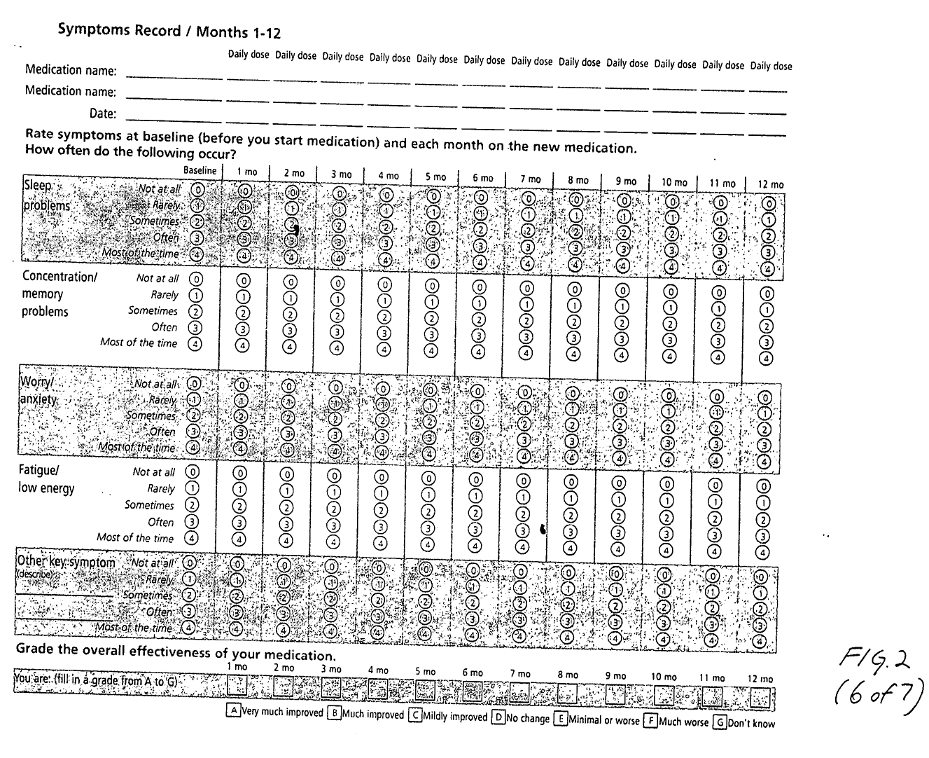

FIG. 1 illustrates one exemplary embodiment of an apparatus 100, which may include (i) a medical manifestation record 110, (ii) a choice of medication record 120, (iii) a patient and/or health care professional education record 130 and/or (iv) a follow-up record 140, for example, to monitor symptoms and/or side effects. The apparatus 100 may be a form such as, for example, a hardcopy form and/or an electronic form. FIG. 2 illustrates another exemplary embodiment of the apparatus 100.

Medical Manifestation Record 110

A symptom inventory may identify, for example, one or more medical signs and/or symptoms, one or more medication side effects, one or more medications, one or more food, one or more beverages and/or one or more activities. The symptom inventory may include one or more lists (e.g., check lists). The symptom inventory may also include symptoms associated with depressive and/or anxiety disorders such as, for example, bipolar illness and obsessive compulsive disorder. For example, depression in the elderly in primary care visits is highly prevalent, yet often missed. The symptom inventory may ask about prior times when an individual may have experienced a symptom, as a history of one or more symptoms in the past may facilitate a diagnosis. The extent of one or more medical signs, medical symptoms and/or medication side effects associated with the individual may be identified through one or more marks (e.g., check marks).

The symptom inventory may include a patient work sheet and/or a health care professional worksheet. The patient work sheet may identify a plurality of medical signs and/or symptoms and/or not a plurality of causes of the plurality of medical signs and/or symptoms. The health care professional worksheet may identify the plurality of medical signs and/or symptoms and/or the plurality of causes of the plurality of medical signs and/or symptoms. For example, a plurality of medical categories (e.g., a plurality of causes of the plurality of medical signs and/or symptoms) (i) may not be revealed, through the patient work sheet, to the individual and/or (ii) may be revealed, through the health care professional worksheet, to a health care professional. The plurality of medical categories may include depression, anxiety, unstable mood and/or obsession.

Choice of Medication Record 120

The apparatus may include a list (e.g., a one-page list) of medications (e.g., common drugs), their doses and/or common side effects. These may be grouped into several general categories. The medications may include a vitamin, a herbal product, a supplement (e.g., a nutritional supplement), an over-the-counter medication and/or a prescription medication. The apparatus may establish, in part or in whole, one or more medications that alleviates the one or more medical signs, medical symptoms and/or medication side effects associated with the individual. The apparatus may also include at least one of (i) one or more uses, (ii) directions, (iii) ingredients, (iv) features, (v) forms, (vi) one or more labels, (vii) warnings, (viii) cautions and (ix) side effects associated with the medications.

Patient and/or Health Care Professional Education Record 130

The apparatus may include information associated with at least one of (i) what to expect from a medication, (ii) tracking medical progress, (iii) adjusting the medication, (iv) managing medication side effects and (v) how long to take the medication and why (see, for example, FIG. 2).

Follow-Up Record 140

If a decision is reached to treat the symptoms and/or signs, the apparatus may provide an easy framework for the patient and/or clinician to monitor symptom relief and/or the emergence (or not) of any side effects that might occur on a regular basis. At least the extent of one or more medical signs, medical symptoms and/or medication side effects associated with a person may be recorded, through the follow-up record 140, at least one of (i) daily, (ii) weekly, (iii) biweekly and (iv) monthly for a period of at least one of (i) one or more days, (ii) one or more weeks, (iii) one or more months and (iv) one or more years. Based on the progress and/or emergence or not of side effects, for example, indicated on the follow-up record 140, the necessary adjustment in a therapeutic approach may be made.

The apparatus may include a year's worth of monthly ratings, for example, as it is recommended that depressed patients continue on medication for six to nine months after they have recovered from their depressive episode. An extended period of monitoring may decrease the incidence of relapse compared to early termination of the drug(s) as is common mode of treatment in the United States where the need for continuation of treatment has not been widely promulgated or accepted. It is conventional thinking that it is a demonstration of strength to stop medications and weakness to continue on them, despite the very considerable suffering, disability, and increased medical risk that a recurrence might engender. The apparatus may educate patients, for example, about the treatment, and may encourage them to continue with the treatment (e.g., psychotropic medication treatment) through a recommended time period.

Contributing factors to inadequate continuation in treatment include lack of information and substantial stigma, for example, about psychiatric illnesses and their treatment. In addition to the general stigma about psychiatric illness and its appropriate treatment is the recent spate of reports and newspaper articles questioning the acute efficacy of the antidepressants. What these articles all fail to discuss is that depression is an episodic illness making short term comparison with placebos difficult. High relapse rates also occur following discontinuation of antidepressants or adjusting depression medication in the elderly. In addition, if one stays on the antidepressants for a longer term there is unequivocal evidence of their ability to prevent future recurrences. For example, the general rule of thumb endorsed by scientific and academic bodies suggests that after three prior major depressions that the individual should strongly consider long term maintenance treatment to prevent further recurrences.

Several medical analogies may also be helpful, for example, in fostering understanding of the need for long term maintenance treatment in those with a number of prior depressive recurrences. Treatment of high blood pressure with medications for months to years does not reverse the basic defect, and one requires long term maintenance treatment in this regard. Similarly with digitalis which increases the strength of contractility of the heart (important in the treatment and prevention of congestive failure), one would never try out the experiment of discontinuing digitalis and seeing whether a patient, friend or relative went into irreversible congestive heart failure and pulmonary edema. Yet this is exactly the experiment that many depressed patients try on themselves. Not only does this increase the risk of depressive occurrence, but with each successive depression, there is a further ten percent risk of chronicity—that the depressive episode is not amenable to treatment.

This range of data, for example, on the under recognition, misdiagnosis, under treatment and relatively high recurrence rates of untreated depression have long been known. The situation, however, may change, for example, in view that information now indicates that antidepressants may protect brain functioning as well as cell survival and generation of new neurons and can counter the effects of stress. One may be able to help change from the exclusive view that the antidepressants are medicines with side effects and are potentially dangerous to the view that they may have medical and life saving benefits, and also help protect the brain and facilitate the growth of new neurons. In addition, another factor is also the increasing recognition that depression is a powerful risk factor for the occurrence of many other medical illnesses and a prognostic factor in their ultimate positive outcome.

The apparatus may be structured to put a premium on patient participation and/or reliance on patient monitoring of symptoms and/or medication side effects in order to minimize the time requirements for physicians and/or other clinical and medical staff. Even in a minimalistic form, the apparatus is useful. Moreover, if other more detailed evaluations and/or rating instruments are required, they may be added to the apparatus. The apparatus may be a diagnostic instrument, although it may not substitute for careful clinical evaluation and discussion. At the same time, the apparatus provides a convenient readily accessible combination of symptom inventory and/or record of treatment follow-up that should prove of great assistance to the patient with symptoms and/or medical difficulties.

Medications

Presently, the health care industry distributes medications through a two-class system, prescriptions and nonprescriptions. When a drug becomes classified as a nonprescription, the medication is made available for direct use by consumers. Presently, a variety of prescription drugs have become readily available as nonprescription drugs. The American Pharmaceutical Association reports that in 1998 consumers spent approximately $17 billion in purchasing over-the-counter medications. As the use of nonprescription medication increases, concerns about self-prescription and patient safety have also increased.

People have a misconception that they don't need to be as careful when taking over-the-counter medications because they can take them without a doctor's prescription. That assumption can pose a serious threat to a person's health. Potential risks are involved with taking medication, whether prescriptions and/or nonprescriptions, such as, for example, interaction with other medications, food, beverages and/or medical conditions. In 1998, more than one-fourth of all hospitalizations were the result of adverse drug events, costing the health care industry $76 billion annually.

The wide variety of products available can be overwhelming to any person trying to determine the medication for a particular medical condition. With the extensive and rapidly increasing medications available today, it has even become difficult for health care providers to be aware of all the drugs and their generic equivalents, interactions and/or side effects. The fact is that concerns, for example, about self-prescription and/or patient safety are real.

One embodiment of a method (e.g., automated method) is provided to simplify choosing a medication treatment that is safe and effective for a person (see, for example, FIGS. 1-3). The method also allows a patient and/or a health care professional to be informed on the medication they will be prescribing and/or taking. The method may provide the patient with questions relating to symptoms so as to establish a disorder (e.g., a preliminary disorder) and/or the medication treatment based, in part or in whole, on answers provided by the patient to the questions.

An exemplary method may present information identifying a plurality of medical signs, medical symptoms and/or medication side effects. The method may ask a person (e.g., a patient) a plurality of questions (e.g., diagnostic questions) associated with medical signs, symptoms and/or side effects. The questions may be answered, through an oral and/or non-oral communication, with a “yes” and/or a “no” response. The questions may also be designed to elicit, through an oral and/or non-oral communication, a numeric response, where the numeric response relates to a frequency at which the person is experiencing medical signs, symptoms and/or side effects. The questions may elicit information associated with the person such as, for example, age, weight, height, sex, allergies, current conditions, relevant family and/or medical history, prescribing physician and/or dispensing pharmacy.

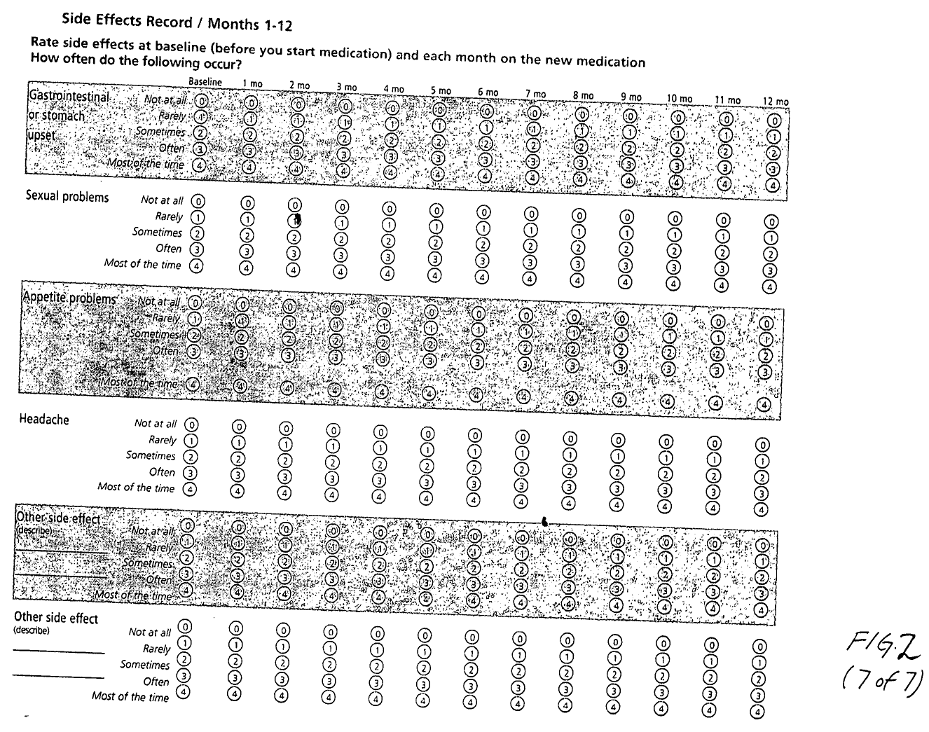

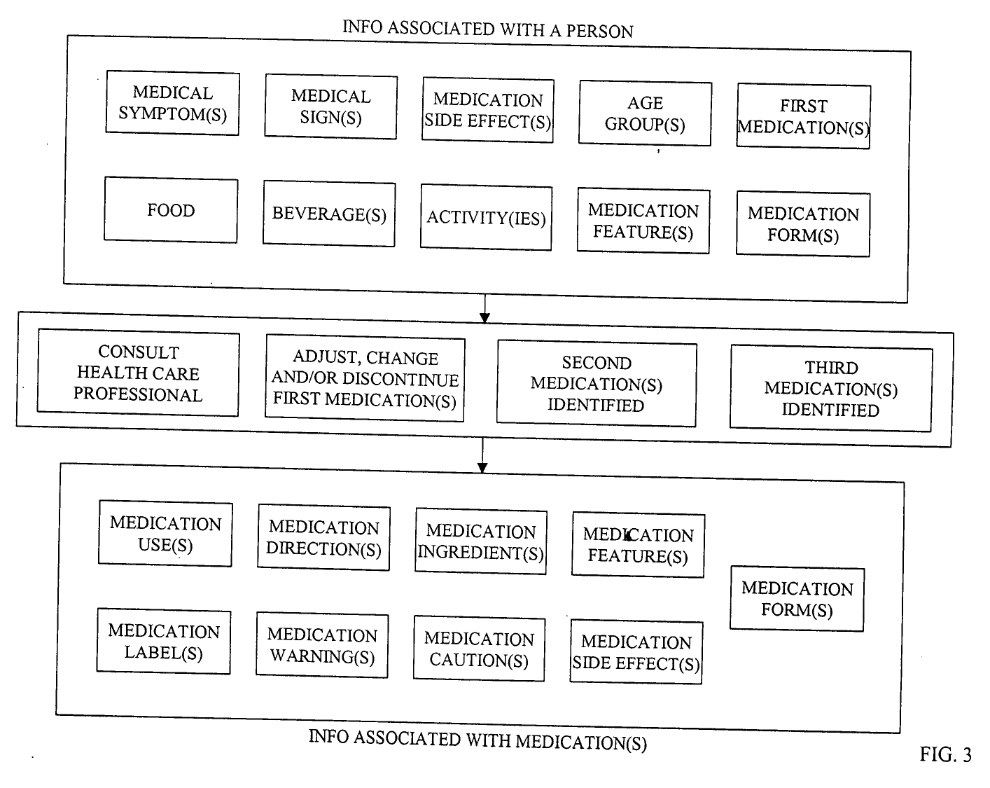

The method may designate and/or record, through the person's answers to the questions, at least one of (i) one or more medical signs, medical symptoms and/or medication side effects, for example, from the plurality of medical signs, medical symptoms and/or medication side effects, (ii) one or more first medications (e.g., a medication remedy), (iii) one or more food, (iv) one or more beverages, (v) one or more activities, (vi) one or more medication forms and (vii) one or more groups (e.g., one or more age groups) (see, for example, FIG. 3). The one or more activities may include exercising, smoking, driving a motor vehicle, operating machinery and/or soaking sunlight. The one or more medication forms may include a pill, a spray, a drop, a cream, a lotion, a tablet, a caplet, a liquid, a gelcap and/or a capsule. The one or more groups may include child (e.g., child under 6 and/or 12 years of age), adult, pregnant and/or older adult.

One or more of the person's answers may be designated though at least one of (i) pressing a first button, (ii) clicking a second button, (iii) touching a screen, (iv) oral and/or non-oral communication, (v) one or more forms (e.g., hardcopy and/or electronic form), (vi) one or more marks (e.g., a checkmark) and (vii) one or more lists (e.g., a checklist). The extent of one or more medical signs, medical symptoms and/or medication side effects associated with the person may be designated for a period of one or more days, one or more weeks, one or more months and/or one or more years (see, for example, FIG. 2).

The information may be designated and/or recorded while a patient is being interviewed and/or from medical records taken by a health care professional during an examination. The method may also obtain information from an individual through an automated interactive interview and/or a self-rating questionnaire.

The one or more medical signs, medical symptoms and/or medication side effects may be grouped under a plurality of medical categories (see, for example, FIG. 2). The one or more medical signs, medical symptoms, medication side effects and/or medical categories may be associated with a physical, emotional and/or mental condition, depression, anxiety, unstable mood, obsession, cardiovascular, diabetes, gastrointestinal, infection, migraine, ophthalmic, pain and/or arthritis, respiratory, urologic disorders, women's health, headache, convulsion and/or seizure, chest pain, heatstroke, tremor, dizziness, irregular heartbeat, fainting, shortness of breath, chest injury, head injury, cough, croup, high blood pressure, hyperventilation, numbness, wheezing, allergies, inhalation injury and/or strokes. The one or more medical signs and/or symptoms may also be associated with sleep problems, concentration and/or memory problems, worry and/or anxiety and/or fatigue and/or low energy. The one or more medication side effects may also be associated with gastrointestinal and/or stomach upset, sexual problems, appetite problems and/or headaches.

The method may identify (e.g., automatically identify) one or more second medications that at least one of (i) alleviates the one or more medical signs, medical symptoms and/or medication side effects, (ii) does not interact with the one or more first medications, the one or more food and/or the one or more beverages, (iii) can be taken without avoiding the one or more activities, (iv) comes in the one or more medication forms and (v) can be used by the one or more groups. The one or more second medications may be identified without the need to seek the advice of a health care professional and/or without the need to read a medication label. The method may purchase, through a pharmacy, a store (e.g., a supermarket) and/or a service (e.g., an online service), the one or more second medications.

The method may also identify (e.g., automatically identify) whether to (i) consult a health care professional and/or (ii) take, adjust, change and/or discontinue a medication remedy (e.g., the one or more first and/or second medications) associated with a person depending, in whole or in part, upon the extent of the one or more medical signs, medical symptoms and/or medication side effects associated with the person. Depending on the answers, the person may be told to contact a pharmacist, a nurse and/or doctor and/or be given an appointment to be examined.

The method may further present (e.g., automatically and/or through the one or more forms) information associated with at least one of (i) the one or more second medications and (ii) one or more third medications, both of which may alleviate the one or more medical signs, medical symptoms and/or medication side effects associated with the person. The information associated with the one or more second and/or third medications may be identified, through hyperlinks, for linking and/or reviewing.

The information associated with the one or more second and/or third medications may include at least one of (i) medication use, (ii) medication directions (e.g., dosage, frequency and/or duration), (iii) medication ingredients, (iv) medication features (e.g., regular and/or extended release), (v) medication forms, (vi) medication label, (vii) medication warnings, (viii) medication cautions and (ix) medication side effects. The information associated with the one or more second and/or third medications may include at least one of (i) who should not take the one or more second and/or third medications, (ii) other medication that may interact with the one or more second and/or third medications, (iii) side effects associated with the one or more second and/or third medications, (iv) food and/or beverages to avoid while taking the one or more second and/or third medications and (v) activities to avoid while taking the one or more second and/or third medications.

Medications may have a synergistic effect with other drugs, foods and/or beverages. For example, the bioflavonoid constituents in grapefruit juice may cause clinically significant drug interactions. Herbal products may contain numerous pharmacologically active constituents that potentially participate in herb-drug interactions. Also, many people take decongestants as they battle colds. If these people have high blood pressure, they should not take the decongestants, which may cause blood pressure to rise.

The method may then select the one or more second and/or third medications depending, in part or in whole, upon the information associated with at least one of (i) the one or more second medications and (ii) the one or more third medications.

The one or more second medications, for example, may treat individual symptoms, whereas the one or more third medications, for example, may treat a combination of symptoms. If the person only has one or more symptoms (e.g., a cough but not a stuffy or runny nose), the individual symptoms may be treated with the one or more second medications, rather than take a combination medication and treat symptoms the person does not have. Also, the person may not get enough of a particular active ingredient when taking a combination product and/or may overdose on an ingredient if a combination medication is taken in conjunction with another drug. If the person has multiple symptoms, the person may be treated with a combination medication.

The one or more first, second and/or third medications may include at least one of (i) a vitamin, (ii) a herbal product, (iii) a supplement (e.g., a nutritional supplement), (iv) an over-the-counter medication and (v) a prescription medication. A side effect and/or a dose associated with the one or more first, second and/or third medications may also be identified (e.g., automatically identified). The one or more first, second and/or third medications may be identified through a trade name and/or a generic name.

The method may provide its information in different languages and/or to translate information from one language to another. For example, English language text and information may be translated to Spanish to permit Spanish-speaking individuals to effectively use the method.

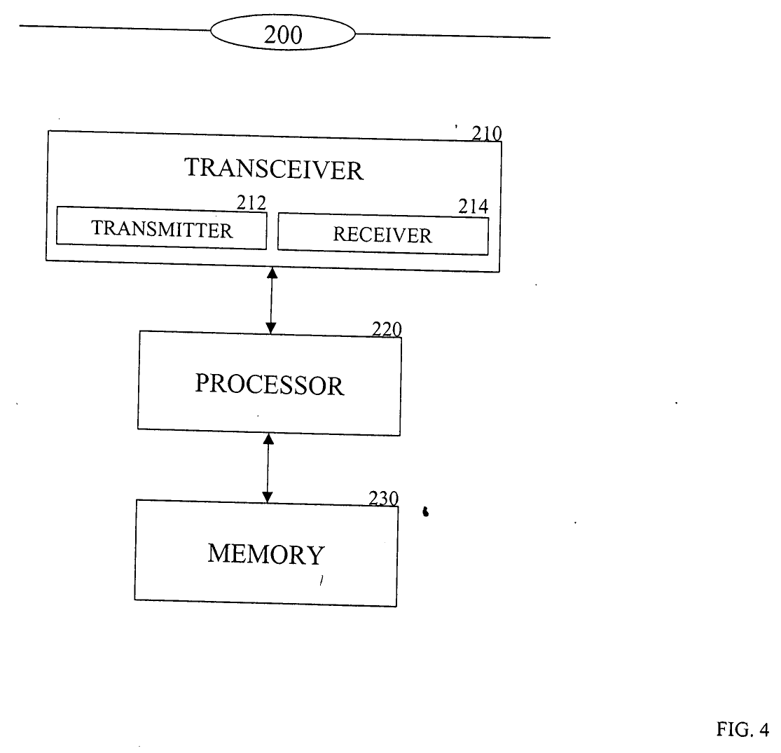

FIG. 4 illustrates one implementation of a machine 200, for example, configured to effect the described embodiments. The machine 200 may include a computer such as, for example, a server, a laptop, a desktop, and/or handheld computer. The machine 200 may also include a display device and/or a printer. The machine 200 further includes a transceiver 210, a processor 220, and a memory 230. The transceiver 210 may include a transmitter 212 that may transmit information, for example, to a network (not shown) over a communications link (not shown), the display device and/or the printer. The network may include a wide area network (WAN) (e.g., Internet), or a local area network (LAN) (e.g., Intranet), or the like, where the communications link may be a direct land line, or a radio communications link, such as a microwave link, satellite link, or the like. The transceiver 210 may also include a receiver 214 that may receive information, for example, from the network over the communications link. Such transmission and reception operations over the communications link may be conducted using the same or different data rates, communications protocols, carrier frequencies, and/or modulation schemes. Likewise, the operations and/or circuit configurations of the transmitter 212 and the receiver 214, respectively, may be completely independent of one another or, alternatively, may be partially or fully integrated.

The processor 220, which may comprise one or more microprocessors, microcontrollers, and/or other arrays of logic elements, may control the operation of the machine 200 according to a sequence of commands that may be (i) stored in the memory 230 and/or in another storage device within or coupled to the machine 200, (ii) entered by a user through an interface such as a data entry device (e.g., a keypad, touch screen and/or speech recognition interface) (not shown), and/or (iii) received from the network over the communications link.

The memory 230, which may comprise read-only memory (ROM), random-access memory (RAM), nonvolatile memory, an optical disk, a magnetic tape, and/or magnetic disk, stores programmable parameters and may also store information including executable instructions, non-programmable parameters, and/or other data.

The memory 230 may store the health manifestation record 110, the choice of medication record 120, the patient and/or health care professional education record 130 and/or the follow-up record 140. The memory 230 may also store information associated with medical signs, medical symptoms and/or medication side effects, medications, foods, beverages, activities, medication forms and/or groups (see, for example, FIG. 3). The memory 230 may further store information associated with medication use, medication directions, medication ingredients, medication features, medication label, medication warnings, medication cautions and medication side effects (see, for example, FIG. 3).

The memory 230 may be within and/or coupled to the machine 200. Executable instructions defining a method associated with the presented embodiments may also be stored in the memory 230 for execution by the processor 220. The method may be programmed when the machine 200 is manufactured or via a machine-readable medium at a later date. Such a medium may include any of the forms listed above with respect to the memory 230 and may further include, for example, a carrier wave modulated, or otherwise manipulated, to convey instructions that can be read, demodulated/decoded and executed by the machine 200.

The machine 200 may be accessible to at least a customer and/or a member associated with a pharmacy, a store and/or a service (e.g., an online service). The machine 200 may also be located in the pharmacy, the store and/or the service, and may used by at least the customer and/or the member.

In sum, the described embodiments may facilitate treatment and/or follow-up, and may indicate whenever more comprehensive evaluation and/or exploration of range of options may be needed. Referral and/or consultation may be indicated whenever treatment does not progress as expected or there is an acute risk of harm, for example, by suicide. Referral for therapy in addition to medications may also be valuable. The apparatus may include a self rated instrument that facilitates the treatment of symptoms, enhances a patient's overall medical health and/or reduces considerable risk factors for the onset of a series of other major medical illnesses.

In view of the foregoing, it will be apparent to one of ordinary skill in the art that the described embodiments may be implemented in software, firmware, and/or hardware. The actual software code or specialized control hardware used to implement the present invention is not limiting of the invention. Thus, the operation and behavior of the embodiments is described without specific reference to the actual software code or specialized hardware components. The absence of such specific references is feasible because it is clearly understood that artisans of ordinary skill would be able to design software and/or control hardware to implement the embodiments of the present invention based on the description herein.

The foregoing presentation of the described embodiments is provided to enable any person skilled in the art to make or use the present invention. Various modifications to these embodiments are possible, and the generic principles presented herein may be applied to other embodiments as well. For example, the invention may be implemented in part or in whole as a hard-wired circuit, as a circuit configuration fabricated into an application-specific integrated circuit, or as a firmware program loaded into non-volatile memory or a software program loaded from or into a data storage medium as machine-readable code, such code being instructions executable by an array of logic elements such as a microprocessor or other digital signal processing unit, or some other programmable machine or system. As such, the present invention is not intended to be limited to the embodiments shown above, any particular sequence of instructions, and/or any particular configuration of hardware but rather is to be accorded the widest scope consistent with the principles and novel features disclosed in any fashion herein.

1-67. (canceled)

68. An apparatus comprising:
means for displaying to a patient one or more medical signs, medical symptoms and/or medication side effects;
means for inputting by a patient said one or more medical signs, medical symptoms and/or medication side effects;
means for receiving said inputted information identifying at least one of (i) one or more medications associated with a person and (ii) the extent of one or more medical signs, medical symptoms and/or medication side effects associated with the person;
means for processing coupled to means for receiving, to make a determination whether to adjust, change and/or discontinue the one or more medications associated with the patient depending, in whole or in part, upon the extent of one or more medical signs, medical symptoms and/or medication side effects associated with the person; and
means for transmitting, coupled to means for processing, to send information identifying whether to adjust, change and/or discontinue the one or more medications associated with said patient.

69. The apparatus of claim 68, wherein the one or more medications includes at least one of (i) a vitamin, (ii) a herbal product, (iii) a supplement, (iv) an over-the-counter medication and (v) a prescription medication.

70. The apparatus of claim 68, wherein the one or more medical signs, medical symptoms and/or medication side effects is associated with at least one of (i) sleep problems, (ii) concentration and/or memory problems, (iii) worry and/or anxiety and (iv) fatigue and/or low energy.

71. The apparatus of claim 68, wherein the one or more medical signs, medical symptoms and/or medication side effects is associated with at least one of: stuffy nose, runny nose, sinus trouble, congestion, cold, flu, sinusitis, allergies, bad taste in mouth, blurred vision, constipation, delayed urination, difficulty having an erection, difficulty having an orgasm, dizziness, dry mouth, forgetfulness, frequent urination, headaches, heart racing or pounding, increased appetite, muscle twitching or clenching, nausea, nightmares, stress, poor concentration, poor sleep, rash, ringing in ears, spasms or drawing of muscles, sweating, thirst, tingling or numbness, trembling, uncomfortable urge to move about, unsteadiness, weight gain, itch, watery eyes, eye redness, sneezing, itchy throat, and hives.

72. The apparatus of claim 68, wherein the one or more medical signs, medical symptoms and/or medication side effects is associated with at least one of (i) gastrointestinal and/or stomach upset, (ii) sexual problems, (iii) appetite problems and/or (iv) headaches.

73. The apparatus of claim 68, wherein the apparatus is located in at least one of (i) a pharmacy and (ii) a store to be used by at least a customer of at least one of (i) the pharmacy and (ii) the store.

74. The apparatus of claim 68, wherein the apparatus is accessible to at least a customer of at least one of (i) a pharmacy, (ii) a store and (iii) an online service.

75-87. (canceled)

88. A machine-readable medium having encoded information, which when read and executed by a machine causes a method comprising:
displaying to a patient at least one of (i) one or more medications associated with a person, (ii) the extent of one or more medical signs and/or symptoms associated with the person and (iii) the extent of one or more medication side effects associated with the person;
inputting by said patient said at least one of (i) one or more medications associated with a person, (ii) the extent of one or more medical signs and/or symptoms associated with the person and (iii) the extent of one or more medication side effects associated with the person;
receiving said inputted information identifying at least one of (i) one or more medications associated with a person and (ii) the extent of one or more medical signs, medical symptoms and/or medication side effects associated with the person; and
processing, responsive to said inputted information, adjusting, changing and/or discontinuing the one or more medications associated with the person depending, in whole or in part, upon at least one of (i) the extent of the one or more medical signs and/or symptoms associated with the person and (ii) the extent of the one or more medication side effects associated with the person.

89. The machine-readable medium of claim 88, wherein at least one of (i) the one or more medications, (ii) the one or more medical signs and/or symptoms and (iii) the one or more medication side effects is designated though at least one of (i) pressing a first button, (ii) clicking a second button and (iii) touching a screen.

90. The machine-readable medium of claim 88, wherein at least one of (i) the one or more medications, (ii) the one or more medical signs and/or symptoms and (iii) the one or more medication side effects is designated through at least one of (i) one or more marks and (ii) one or more lists.

91. The machine-readable medium of claim 88, wherein the one or more medications includes at least one of (i) a vitamin, (ii) a herbal product, (iii) a supplement, (iv) an over-the-counter medication and (v) a prescription medication.

92-111. (canceled)

112. An apparatus for compliance-driven monitoring of a treatment program of a patient comprising:
means for displaying at least one of the group consisting of medical signs, medical symptoms, and medication side effects and at least one descriptor identifying said patient's status related to said at least one of the medical signs, medical symptoms, and medication side effects, said presentation being repeated on said medium at temporal intervals;
means for inputting on said medium said at least one descriptor identifying said patient's status related to said one of said medical signs, medical symptoms, and medication side effects at said at least one temporal intervals; and
means for monitoring, responsive to said inputted at least one descriptor, said patient's compliance with said treatment program.

113. The apparatus of claim 112 further comprising:
means for determining, responsive to said monitoring, the effectiveness of said treatment program for said patient.

114. The apparatus of claim 112 wherein said at least one temporal intervals is at least one period selected from the group consisting of (i) baseline, (ii) one or more days, (iii) one or more weeks, and (iv) one or more months.

115. The apparatus of claim 112 wherein said at least one descriptor is selected from the group consisting of not at all, rarely, sometimes, often, and most of the time.

116. The apparatus of claim 112 wherein said at least one of said medical signs, medical symptoms, and medication side effects are grouped under a plurality of medical categories.

117. The apparatus of claim 112, wherein the plurality of medical categories are associated with at least one of depression, anxiety, unstable mood, obsession, cardiovascular, diabetes, gastrointestinal, infection, migraine, ophthalmic, pain and/or arthritis, respiratory, urologic disorders, women's health, headache, convulsion and/or seizure, chest pain, heatstroke, tremor, dizziness, irregular heartbeat, fainting, shortness of breath, chest injury, head injury, cough, croup, high blood pressure, hyperventilation, numbness, wheezing, inhalation injury and strokes.
